(19) United States
(12) Patent Application Publication
(10) Pub. No.: US 2026/0122495 A1
(43) Pub. Date: Apr. 30, 2026

(54) LEVERAGING CLOUD SERVICES FOR ENHANCED SECURE ACCESS SERVICE EDGE (SASE) CONNECTIVITY

(71) Applicant: T-Mobile USA, Inc., Bellevue, WA (US)

(72) Inventors: Anis Adil Anis, Concord, CA (US); Sumanth Bellam, Bellevue, WA (US)

(21) Appl. No.: 18/926,191

(22) Filed: Oct. 24, 2024

(51) Int. Cl. H04W 12/08; H04W 12/69

(52) U.S. Cl. CPC H04W 12/08; H04W 12/69

(57) ABSTRACT

Techniques for enhanced secure access service edge (SASE) connectivity may utilize a cloud service platform to connect the networks of a mobile service operator, an SASE service provider, and the enterprise servers and data centers. When a request to access an enterprise server is received, the mobile service operator may perform authentication on the user ID and determine the domain the user ID is authorized to access. Once the user ID is authenticated and authorized, the request is forwarded to the cloud service platform. The cloud service platform may maintain a configuration indicative of a mapping between the user ID and the SASE server designated to the user ID. The cloud service platform may route the request to the SASE server based on the configuration. The SASE server may further establish a secure access channel through the cloud service platform for the user ID to access the enterprise server.

Secure access service edge (SASE) is a framework for network architecture that brings cloud native security technologies together with wide area network capabilities to securely connect users, systems, and endpoints to applications and services anywhere. The SASE framework combines a software-defined wide area network (SD-WAN) or other WAN with multiple security capabilities (e.g., cloud access security broker, anti-malware, etc.) to secure the network traffic. However, SASE solutions often face challenges due to limited edge proximity and tightly coupled horizontal and vertical scalability. These constraints can result in higher latency and potential performance deterioration, particularly, for the users located far from the edge nodes or for the applications with high performance demands.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 illustrates an example scenario, in which, methods of leveraging cloud services for enhanced SASE connectivity according to an example of the present disclosure.

FIG. 2 illustrates an example scenario, in which, methods of providing a secure connectivity between a mobile device and enterprise data and applications through SASE connectivity is implemented according to a prior implementation.

FIG. 3 illustrates an example process for leveraging cloud services for enhanced SASE connectivity according to an example of the present disclosure.

FIG. 4 illustrates a flow diagram of an example process for leveraging cloud services for enhanced SASE connectivity according to an example of the present disclosure.

FIG. 5 illustrates an example computing device, in which methods for leveraging cloud services for enhanced SASE connectivity according to an example of the present disclosure.

### DETAILED DESCRIPTION

Techniques for leveraging cloud services for enhanced secure access service edge (SASE) connectivity are disclosed herein. In some implementations, a method for leveraging cloud services for enhanced SASE connectivity may be implemented by one or more computing devices associated with a cloud service platform. The network of a mobile service operator, the network of the SASE service platform, and the enterprise servers/data centers may all connect to the cloud service platform via Internet, virtual private network (VPN), multiprotocol label switching (MPLS), etc. The SASE service provider may provide a pre-established configuration data to the cloud service platform. The cloud service platform may act as a routing mechanism to route the traffic from the mobile service operator to the enterprise entity (e.g., application server, data center, etc.) through the secure access channel provided by the SASE service platform.

The computing device associated with the cloud service provider may include a processor and a non-transitory computer-readable memory storing computer-executable instructions that, when executed by the processor, cause the processor to facilitate a secure connectivity between a mobile device and the enterprise data center and/or application servers through an SASE service platform. In some examples, the computing device on the cloud service platform may receive a request from a mobile service operator to access a network entity. The request may be generated from a user equipment (UE) associated with a mobile subscriber of the mobile service provider. The network entity may be an enterprise server, an application server, and/or a data center.

In implementations, the request may include a user identity (ID) that identifies a mobile subscriber and/or the UE associated with the mobile subscriber. The user ID may include data that identifies a SIM card and/or a e-SIM card of the UE, e.g., an international mobile equipment identity (IMEI) number of the UE.

In implementations, the computing device in the cloud service platform may determine the SASE server to forward the request based on configuration data. In implementations, the configuration data may be generated based on an agreement between the SASE service provider and the customer such as an enterprise. The configuration data may include a first mapping between the user IDs or access IDs and the customers or customer networks (also referred to as “tenants”). In some examples, the configuration data may include a second mapping between the user IDs and the SASE servers, through which, the traffic associated with a particular user ID is routed to the customer network. The configuration data may be primarily stored in a database of the SASE service provider. In implementations, the SASE service provider may share a portion of the configuration data with the cloud service provider, for example, the second mapping between the user IDs and the SASE servers.

In some examples, the mobile service operator may perform authentication on the user ID before forwarding the request to the SASE service provider. The mobile service provider may forward the request only when the authentication on the user ID succeeds. The mobile service provider may establish a protocol data unit (PDU) session for the UE to access the network entity and assign an IP address for the PDU session. The mobile service provider may forward the request along with the user ID and the IP address to the cloud service platform.

In implementations, upon receiving the request from the mobile service operator, the cloud service platform may route the request to an SASE server designated to provide a secure access channel for the UE. In some examples, the cloud service platform may refer to the configuration data (e.g., the second mapping defined by the configuration data) and determine the SASE server to receive the request. Upon receiving the request from the cloud service platform, the SASE server may generate a third mapping between the IP address and the network entity (e.g., customer network, application server, data center, etc.) based on the configuration data (e.g., the first mapping defined by the configuration data).

As the user ID has been authenticated and authorized by the mobile service operator, the SASE server may establish a secure access channel for the UE associated with the user ID to connect to the network entity. The SASE server may further forward the request through the secure access channel to the cloud service platform, and share the third mapping with the cloud service platform. Based on the third mapping, the cloud service platform may further route the request to the network entity.

In implementations, traffic associated the authenticated user ID may be routed through the secure access channel from the UE to the network entity via the cloud service platform. The SASE service platform may perform security check on the content of the traffic, e.g., malware detection, domain name system (DNS) filtering, etc. In some examples, the mobile service operator may share, with the SASE service provider, a list of user IDs that are authorized to access the network entity. The SASE service platform may perform an additional check on the user ID by referencing to the list of authorized user IDs to enhance SIM fraud protection.

The present disclosure utilizes the cloud service platforms to connect the networks of the mobile service operator and the SASE service platform. Comparing to the traditional techniques where the mobile service operator and the SASE service provider are connected through wireline, the present disclosure provides a more flexible and resilient connectivity between the mobile service operator and the SASE service provider. Particularly, by centralizing the routing mechanism within the cloud service platform, the network topology can be greatly simplified. The SASE service providers can also benefit from the high scalability high availability and redundancy of the cloud infrastructure to provide more reliable and tailored services to the customers.

The techniques discussed herein may be implemented in a computer network using one or more of protocols including but are not limited to Ethernet, 3G, 4G, 4G LTE, 5G, Sixth Generation (6G), the further radio access technologies, or any combination thereof wherever carrier aggregation concepts and principles apply. Example implementations are provided below with reference to the following figures.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

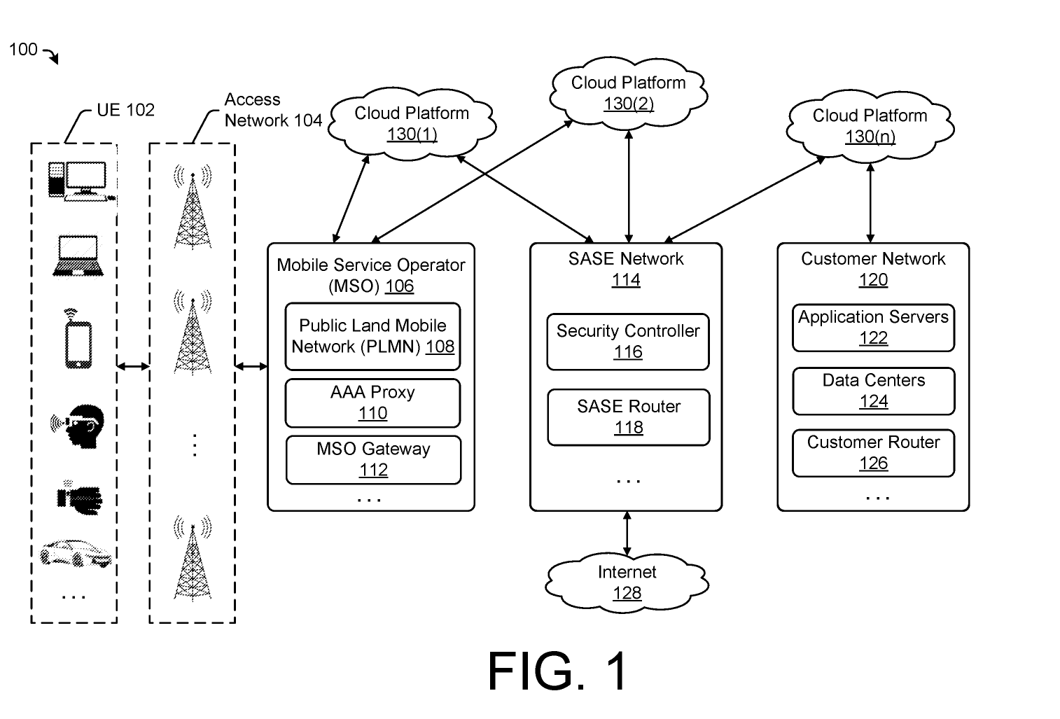

FIG. 1 illustrates an example scenario, in which, methods of leveraging cloud services for enhanced SASE connectivity according to an example of the present disclosure.

The network scenario 100 may include a telecommunication network of a mobile service provider (MSO) 106, a secure access service edge (SASE) network 114, and a customer network 120. In implementations, the connection between the MSO 106 and the SASE network 114, and the connection between the SASE network 114 and the customer network 120 may be through a cloud service platform. As illustrated in FIG. 1, the MSO 106 may connect to the SASE network 114 through cloud platform 130(1) and/or cloud platform 130(2), and the SASE network 114 may connect to the customer network 120 through cloud platform 130(n). The cloud platform 130(1), 130(2), …, or 130(n) may be a public cloud platform that delivers computing resources over the Internet, including but is not limited to, Amazon Web Services (AWS), Google Cloud Platform, Microsoft Azure, IBM Bluemix, etc. The MSO 106 may connect to the cloud platform, e.g., the cloud platform 130(1) and/or the cloud platform 130(2) via Internet, Virtual Private Network (VPN), Multiprotocol Label Switching (MPLS), etc. Additionally, the SASE network 114 may connect to the cloud platform, e.g., the cloud platform 130(2) and/or the cloud platform 130(n) via Internet, VPN, MPLS, etc., and the customer network 120 may connect to the cloud platform, e.g., the cloud platform 130(n) via Internet, VPN, MPLS, etc.

A mobile subscriber may access the resources in the customer network 120 through a secure access channel established between a user equipment (UE) 102, the MSO 106, the SASE network 114, and the customer network 120. For example, the mobile subscriber may use an application installed on the UE 102 to connect to application servers 122 in the customer network 120. In another example, the mobile subscriber may use an application to access the data stored in data centers 124 in the customer network 120. The secure access channel may be provided by the SASE network 114 and through various cloud platforms that bridge the MSO 106, the SASE network 114, and the customer network 120.

In implementations, a request to establish a PDU session may be sent from the UE 102 to the MSO 106. The MSO 106 may perform authentication of the mobile subscriber’s identity and authorize the mobile subscriber to access the resources in the customer network 120. The MSO 106 may further track the activities of the mobile subscriber and the usage of the services/resources. Once the mobile subscriber’s identity is authenticated, the MSO 106 may forward the request to the SASE network 114 through the cloud platform 130(1) and/or the cloud platform 130(2).

The SASE network 114 may establish a secure channel for the UE 102 to the customer network 120. In some examples, the mobile subscriber may use the application installed on the UE 102 to access the resources in Internet 128. Upon receiving the request from the MSO 106, the SASE network 114 may forward the traffic directly to the Internet 128.

A user equipment (UE) 102 may attach to a public land mobile network (PLMN) 108 of the mobile service operator through an access network 104. The UE 102 may be any device that can wirelessly connect to a telecommunication network. The UE may support various radio access technologies such as Bluetooth, Wi-Fi, GSM, CDMA, WCDMA, UMTS, 4G/LTE or 5G NR. In some examples, the UE 102 may be a mobile phone, such as a smart phone or other cellular phone. In other examples, the UE 102 may be a personal digital assistant (PDA), a media player, a tablet computer, a gaming device, or any other type of computing or communication device. In yet other examples, the UE 102 may include the computing devices implemented on the vehicle including but are not limited to, an autonomous vehicle, a self-driving vehicle, or a traditional vehicle capable of connecting to internet. In yet other examples, the UE 102 may be a wearable device and/or wearable materials, such as a smart watch, smart glasses, clothes made of smart fabric, etc. In further examples, the UE 102 may be a virtual reality or augmented reality goggles or glasses.

In implementations, the access network 104 may be compatible with one or more radio access technologies, protocols, and/or standards, such as 5G New Radio (NR) technology, LTE/LTE Advanced technology, other fourth generation (4G) technology, High-Speed Data Packet Access (HSDPA)/Evolved High-Speed Packet Access (HSPA+) technology, Universal Mobile Telecommunication System (UMTS) technology, Code Division Multiple Access (CDMA) technology, Global System for Mobile Communications (GSM) technology, WiMAX technology, Wi-Fi technology, and/or any other previous or future generation of radio access technology. For example, the access network 104 may be a gNB associated with a 5G radio access network (RAN) or an eNB associated with a 4G/LTE RAN. Although not shown, the access network 104 may also be associated with a second generation (2G) base station, a third generation (3G) NodeBs associated with GSM and CDMA access network, digital subscriber line (DSL) and variations of DSL technology that provide access to desktops, workstations, and/or mainframes, Wi-Fi connections to the user equipment, etc. The core network may be referred to as a backbone network of the telecommunication network, such as, a 5G core network, an evolved packet core (EPC) network, etc.

Although not shown, the PLMN 108 of the mobile service operator may include a variety of network functions including but is not limited to, an access and mobility management function (AMF), an authentication server function (AUSF), a session management function (SMF), a network slice selection function (NSSF), a network exposure function (NEF), a network repository function (NRF), a policy control function (PCF), a unified data management function (UDM), an application function (AF), a user plane function (UPF), etc. In some examples, the AMF, the AUSF, the SMF, the NSSF, the NEF, the NRF, the PCF, the UDM, and the AF may form a service based architecture (SBA) in the home PLMN. Through the PLMN 108, the UE 102 may register to the core network of the MSO 106, request to establish a PDU session, send/receive data on the PDU session, etc. In implementations, the MSO 106 may include an authentication, authorization, and accounting (AAA) proxy 110. The AAA proxy 110 may verify a mobile subscriber’s identity by comparing his/her credentials with the data stored in a database of the MSO 106 (e.g., UDM). The mobile subscriber’s credentials may include but are not limited to, the international mobile equipment identity (IMEI), the International Mobile Subscriber Identity (IMSI) of the mobile subscriber, the Mobile Station Integrated Services Digital Network (MSISDN), the Subscription Permanent Identifier (SUPI), the username and password, the biometric data of the mobile subscriber, etc.

In implementations, the AAA proxy 110 may further grant the mobile subscriber to access certain resources or domains of a network or system based on his/her identity, subscribed services, and permissions stored in the database. For example, a mobile subscriber may be permitted to access a certain domain of the data centers 124 in the customer network 120. Additionally, the AAA proxy 110 may track the mobile subscriber’s activity while he/she is connected to the network, including the resources they use and session statistic. In some examples, the MSO 106 may further include an MSO gateway 112 configured to route the traffic through the secure access channel established by the SASE network 114 through the cloud platform 130 to the customer network 120.

In implementations, once the secure access channel is established, the SASE network 114 may continue to receive, via the cloud platform 130(1) and/or the cloud platform 130(2), the data traffic from the MSO 106 to be forwarded to the customer network 120. The data traffic may indicate the user ID and an IP address dynamically assigned to the PDU session established for the UE 102. A security controller 116 in the SASE network 114 may be configured to determine the schemes, policies, or rules to route the data traffic. In some examples, a database of the SASE network 114 may store information that indicates a first mapping between various IDs and the corresponding network entities in the customer network 120. The database of the SASE network 114 may further store a second mapping between various IDs and the SASE servers, through which, the traffic is routed to the entities.

When receiving the data traffic, the security controller 116 may determine a third mapping between the IP address and the network entity in the customer network 120 based on the first mapping between the various IDs and the network entities. An SASE router 118 in the SASE network 114 may further forward, via the cloud platform 130(n), the data traffic to a customer router 126 in the customer network 120 based on the third mapping between the IP address and the corresponding entity. In implementations, the MSO 106 may support multiple PDU sessions between the UEs and the network entities in the customer network 120. The SASE controller 116 may update the third mappings of the IP addresses and the network entities based on the IP addresses dynamically assigned by the MSO 106. Additionally, although the network scenario 100 shows a single customer network 120, multiple customer networks may connect, through the cloud service platform, to the SASE network 114 to use the secure access services.

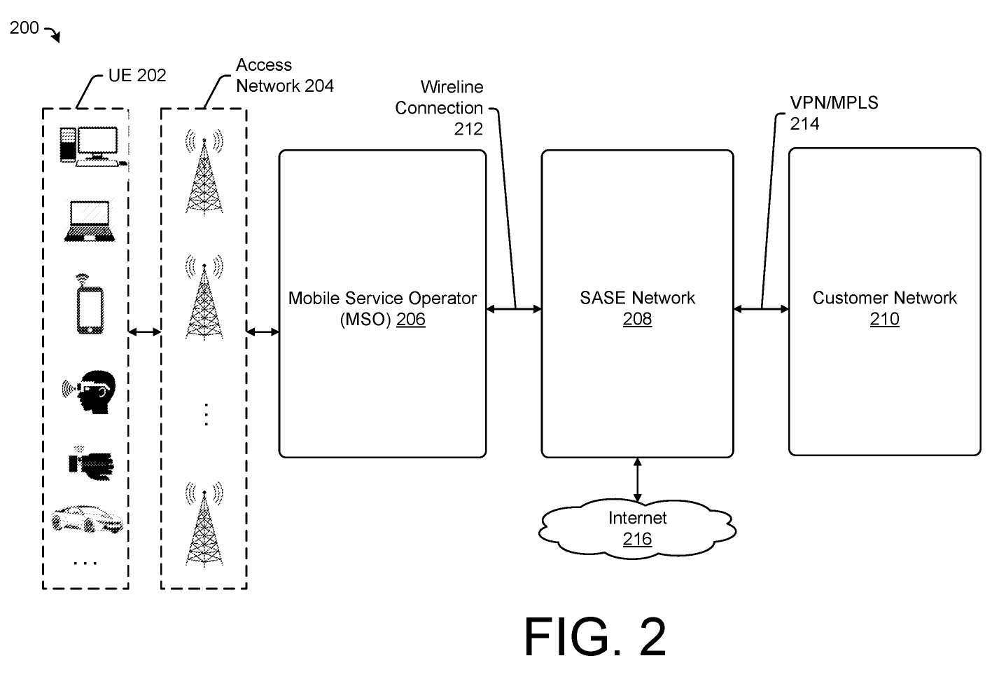

FIG. 2 illustrates an example scenario, in which, methods of providing a secure connectivity between a mobile device and enterprise data and applications through SASE connectivity is implemented according to a prior implementation.

As illustrated in the example scenario 200, UE 202 connects to the network of MSO 206 through access network 204. The UE 202 may access the resources in customer network 210 through a secure access channel provided by SASE network 208. The UE 202 may also access the resources in Internet 216 through the secure access channel provided by the SASE network 208. The network of MSO 206 may connect to the SASE network 208 via a wireline connection 212. For example, the wireline connection 212 may connect a node/location (e.g., network gateway) of the SASE network 208 to the node/location (e.g., network gateway) of the MSO 206 based on the proximity between the nodes. Additionally, the SASE network 208 may connect to the customer network 210 based on the proximity through VPN or MPLS 214. As discussed herein, the prior implementation may rely on the proximity-based connections to minimize the latency of the communication.

According to the present disclosure as illustrated in FIG. 1, the MSO 106, the SASE network 114, and the customer network 120 may all connect to the established cloud platforms. The secure channel between the user equipment and the entity in the customer network may be the virtual connections provided via the cloud platforms. By utilizing the established cloud platforms, the present disclosure leverages the coverage and the advanced networking capabilities of the cloud resources to facilities secure and efficient connectivity for the SASE services. The present disclosure also simplifies the network architecture by reducing the reliance on traditional connectivity methods, and centralizes the traffic routing through the robust network infrastructure of the cloud service providers.

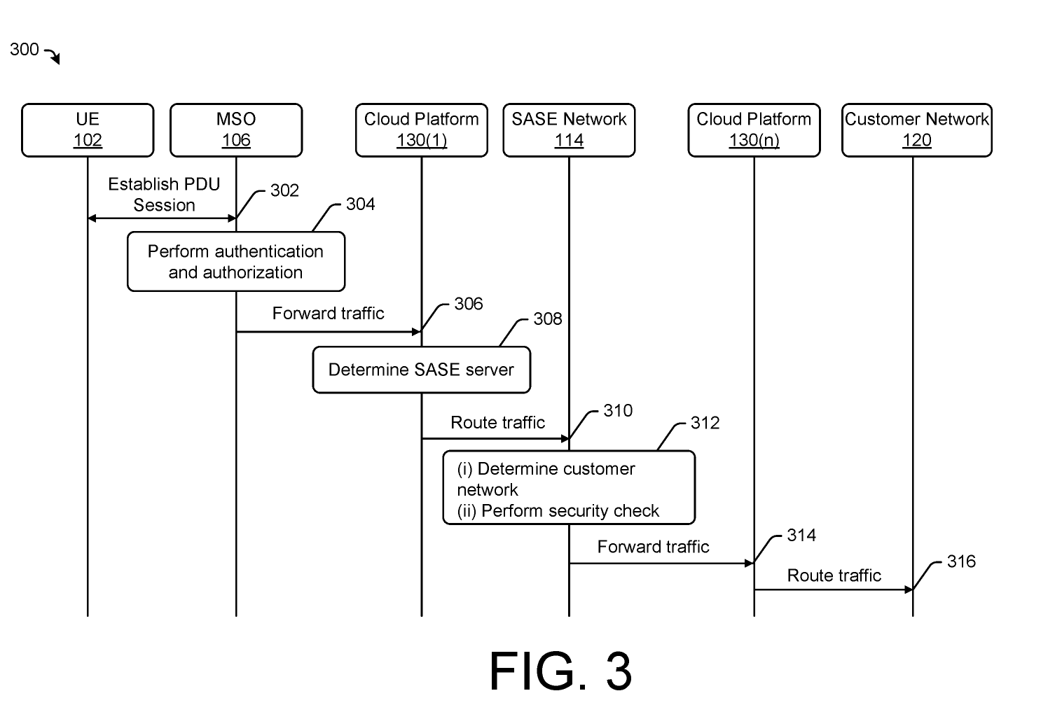

FIG. 3 illustrates an example process for leveraging cloud services for enhanced SASE connectivity according to an example of the present disclosure.

As illustrated in the example process 300, a PDU session may be established between the UE 102 and the MSO 106 at 302. The establishment of the PDU session may include multiple communications among the network functions of the MSO 106. For example, the UE 102 may send a PDU session establishment request to an AMF of the MSO 106 through the access network 104 (e.g., gNB, eNB, 2G/3G base stations, etc.). The AMF may select an SMF to serve the UE 102 based on the requested service, the geographic location of the SMF, the capacity of the SMF, etc. The selected SMF may be further registered at the UDM. The establishment of the PDU session may also include determining a Quality of Service (QoS) level for the PDU session, creating a charging request for the PDU session, etc.

In implementations, the SMF may also send a Remote Authentication Dial-In User Service (RADIUS) request to the AAA proxy 110 of the MSO 106, causing the AAA proxy 110 to perform authentication and authorization at 304. As discussed herein, the AAA proxy 110 may perform the authentication by comparing the identity data in the RADIUS request with the identity data stored in the UDM. Additionally, the AAA proxy 110 may also refer to the data stored in the UDM to determine the services that the mobile subscriber is authorized to use and/or the domains in the customer network resources that the mobile subscriber is authorized to access. If the authentication succeeds, the MSO 106 may forward the request to the cloud platform 130(1) at 306. If the authentication of the user ID fails, the MSO 106 may reject the request.

In implementations, the cloud platform 130(1) may determine an SASE server to provide a secure access channel to the mobile subscriber. The cloud platform 130(1) may store configuration data forwarded by the SASE network 114, where the configuration data includes an association of a list of user IDs and the SASE servers. In some examples, the configuration data may be created when a contract between an enterprise (e.g., the customer) and the SASE service provider is reached. The SASE service provider may share the configuration data with the cloud service platform. Based on the configuration data, the cloud platform 130(1) may determine the SASE server dedicated to providing the secure access link to the mobile subscriber and/or the UE. The cloud platform 130(1) may forward the traffic to the corresponding SASE server in the SASE network 114 at 310.

The configuration data stored in the SASE network 114 may further include mappings between a list of user IDs and a list of customer network. Upon receiving the traffic, at 312, the SASE server in the SASE network 114 may further determine the customer network that the traffic is destined to. As discussed herein, the traffic from the MSO 106 may the user ID and the IP address assigned to a current PDU session. The SASE server may determine, based on the configuration data, a third mapping between the IP address associated with the current PDU session and the network entity. The SASE server may further perform security check on the traffic, including but is not limited to content filtering, malware scanning, Domain Name System (DNS) filtering, Intrusion and Detection Prevention (IDP) etc. In some examples, the SASE server may additionally receive a list of user IDs from the mobile service operator. To further enhance the identity fraud protection, the SASE server may perform an additional check on the identity of the mobile subscriber even if the identity has been authenticated by the mobile service operator.

When the traffic is determined to be clean, the SASE server may forward the traffic to the cloud platform, e.g., the cloud platform 130(n) at 314. In some examples, the SASE server may also forward the third mapping between the IP address assigned to the current PDU session and the customer network to a gateway device in the cloud platform 130(n). The gateway device in the cloud platform 130(n) may further route the traffic to the customer network 120 based on the third mapping (at 316).

As discussed herein, the core network of the mobile service provider (e.g., the MSO 106) may establish a connection to the cloud infrastructure provided by the cloud service provider. The SASE service provider may also connect to the cloud infrastructure in various locations from the core network of the SASE service provider. Further, the entities in the customer network (e.g., application servers 122, data centers 124, etc.) may also connect to the cloud infrastructure, allowing for centralized access and management. The cloud platforms 130(1), 130(2), …, and 130(n) may be configured with routing mechanism for the traffic between the mobile service provider (e.g., the MSO 106), the SASE service provider (e.g., the SASE network 114), and the customer entities (e.g., application servers 122 and data centers 124 in the customer network 120). Comparing to the traditional techniques to connect the mobile service provider and the SASE service provider via direct wireline connection or VPN connection, the present disclosure can provide more flexible and resilient connectivity for secure access service edge.

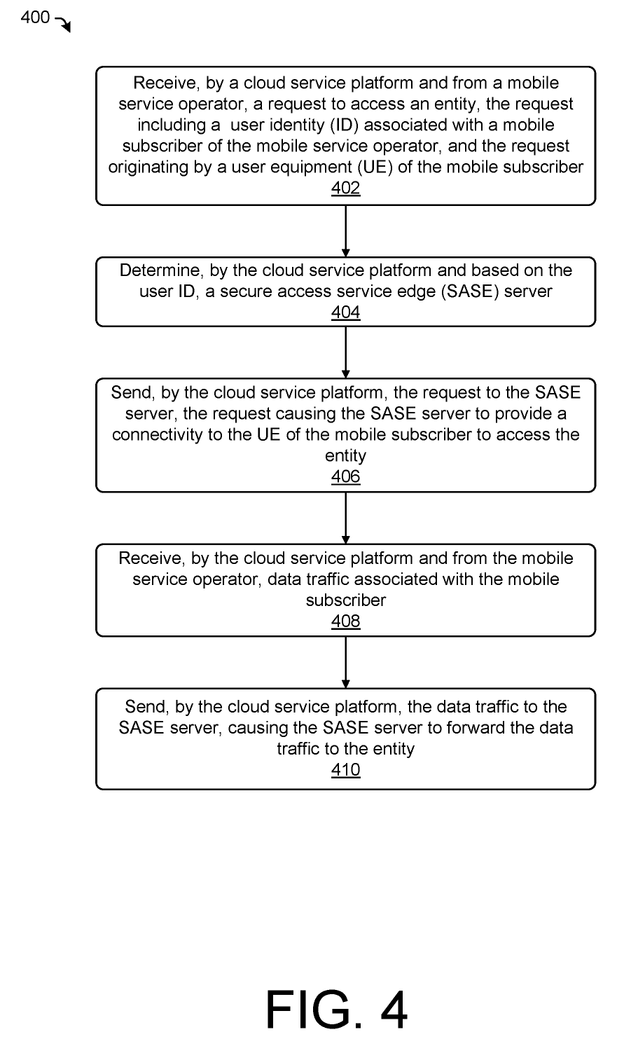

FIG. 4 illustrates a flow diagram of an example process for leveraging cloud services for enhanced SASE connectivity according to an example of the present disclosure. The example process 400 may be performed by a computing device in a cloud service platform, e.g., the cloud platform 130(1), the cloud platform 130(2), …., or the cloud platform 130(n) as shown in FIG. 1.

At operation 402, the process may include receiving, by a cloud service platform and from a mobile service operator, a request to access an entity, the request including a user identity (ID) associated with a mobile subscriber of the mobile service operator, and the request originating by a UE of the mobile subscriber. In some examples, the mobile service operator (e.g., the MSO 106 in FIG. 1) may only forward the request when the authentication of the user ID succeeds. If the authentication of the user ID fails, the mobile service operator rejects the request. In some examples, the user ID associated with the mobile subscriber may be SIM-based identity data such as IMEI, IMSI, MSISDN, etc. In some other examples, the user ID associated with the mobile subscriber may be non-SIM-based identity data such as username and password, face ID, etc.

In implementations, the entity may include a network resource located in a customer network such as an enterprise network, for example, the application servers 122 or the data centers 124 in the customer network 120, as shown in FIG. 1. The request to access the entity may cause the mobile service operator to establish a PDU session for the mobile subscriber. The request may also include an IP address assigned to the PDU session by the mobile service operator.

At operation 404, the process may include determining, by the cloud service platform and based on the user ID, a secure access service edge (SASE) server. As discussed herein, various SASE servers in different locations of an SASE core network may connect to the cloud service platform. Each SASE server may provide the secure access service to one or more customers/enterprises. Thus, each SASE server may maintain configuration data that includes a list of user IDs that are authorized to use the secure access service through the SASE server. In implementations, the configuration data associated with each SASE server may be shared with the cloud service platform. Upon receiving the user ID, the cloud service platform may refer to the configuration data and determine which SASE server is set to provide the secure access service to the user ID.

At operation 406, the process may include sending, by the cloud service platform, the request to the SASE server, the request causing the SASE server to provide a connectivity to the UE of the mobile subscriber to access the entity. A computing device in the cloud service platform, e.g., a router and/or a gateway device, may route the request to the SASE server determined at operation 404. As discussed herein, the request may include the user ID associated with the mobile subscriber and an IP address dynamically assigned for the session. The SASE server may determine the mapping between the IP address and the customer network and/or the entity in the customer network based on the configuration data.

In some examples, the SASE server may determine whether the incoming traffic is safe by implementing various security check operations such as malware detection, DNS filtering, IDP, etc. If the incoming traffic is determined to be safe, the SASE server may forward the traffic to the cloud service platform to route the traffic to the customer network. If the incoming traffic is determined to be unsafe, the SASE server may reject the traffic. In some examples, the third mapping between the IP address designated to the session and the customer network may also be forwarded to the cloud service platform. Based on the mapping between the IP address and the customer network, a gateway device in the cloud service platform may further route the traffic to the destination entity.

In some examples, the mobile service operator may share a list of mobile subscriber identities (e.g., IMEI) with the SASE server. Although the identity of the mobile subscriber has been authenticated by the mobile service operator, the SASE server may cross-check the identity by referring to the list of mobile subscriber identities.

At operation 408, the process may include receiving, by the cloud service platform and from the mobile service operator, data traffic associated with the mobile subscriber. Such data traffic may originate from UE of the mobile subscriber. Once the secure access channel between the UE and the network entity is established, the cloud service platform may receive subsequent data traffic sent from the UE. As the mobile service operator has created a PDU session in response to the request, the subsequent data traffic sent through the secure access channel may be associated with the IP address designated to the PDU session.

At operation 410, the process may include sending, by the cloud service platform, the data traffic to the SASE server, causing the SASE server to forward the data traffic to the entity. As discussed herein, the SASE server may retrieve the IP address from the data traffic and generate a mapping between the IP address and the customer network. Such mapping information may be further shared with the cloud service platform to facilitate routing the data traffic to the customer network. When the current PDU session ends, the IP address designated to the PDU session may be released. A mobile subscriber identity may be assigned with a different IP address when the mobile subscriber sends a new request to use the secure access service.

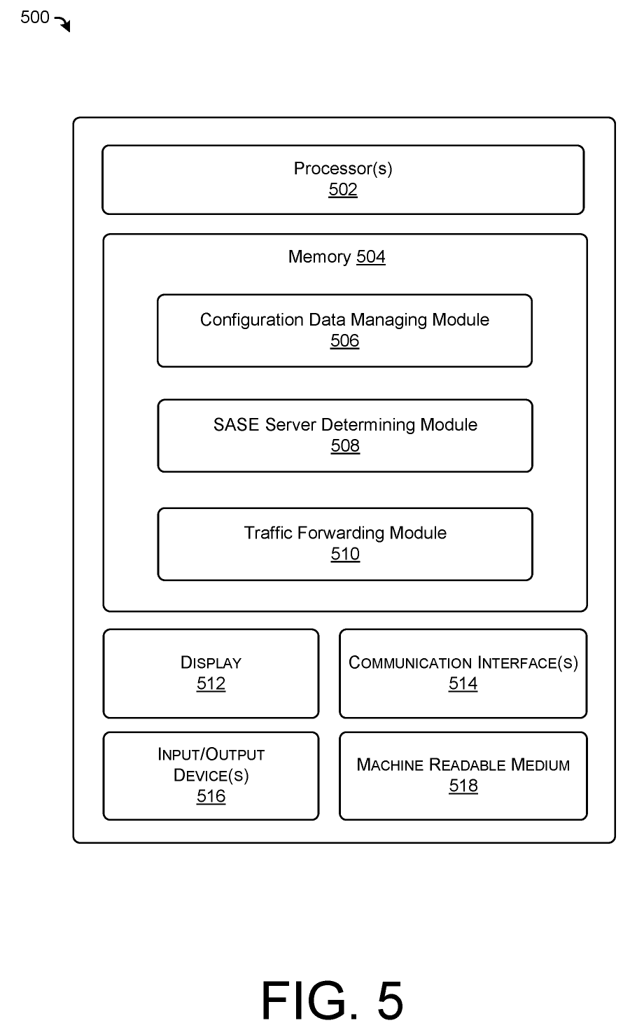

FIG. 5 illustrates an example computing device, in which methods for leveraging cloud services for enhanced SASE connectivity according to an example of the present disclosure. The example computing device 500 may correspond to a computing device, a router, and/or a gateway device, in a cloud service platform.

As illustrated in FIG. 5, a computing device 500 may comprise processor(s) 502, a memory 504 storing a configuration data managing module 506, an SASE server determining module 508, and a traffic forwarding module 510, a display 512, communication interface(s) 514, input/output device(s) 516, and/or a machine readable medium 518.

In various examples, the processor(s) 502 can be a central processing unit (CPU), a graphics processing unit (GPU), or both CPU and GPU, or any other type of processing unit. Each of the one or more processor(s) 502 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 502 may also be responsible for executing all computer applications stored in memory 504, which can be associated with common types of volatile (RAM) and/or nonvolatile (ROM) memory.

In various examples, the memory 504 can include system memory, which may be volatile (such as RAM), non-volatile (such as ROM, flash memory, etc.) or some combination of the two. The memory 504 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store desired information and which can be accessed by the computing device 500. Any such non-transitory computer-readable media may be part of the computing device 500.

The configuration data managing module 506 may be configured to maintain the configuration data shared by the mobile service operation and the SASE service provider. The configuration data managing module 506 may periodically request update from the mobile service operation and the SASE service provider, and update the configuration data based on the responses. In some examples, the configuration data managing module may update the configuration data based on the request from the mobile service operation and the SASE service provider. In implementations, the mobile service operator may send, to the cloud service platform, an ID-to-IP address mapping between various mobile subscriber identities and the corresponding IP addresses for the ongoing PDU session. The SASE service provider may send, to the cloud service platform, a first mapping between the IDs and the customer networks and a second mapping between the IDs and the SASE servers. The configuration data managing module 506 may store the ID-to-IP address mapping, the first mapping, and the second mapping in the configuration data.

The SASE server determining module 508 may be configured to determine a server in the SASE network to provide the secure access connectivity to the UE. As discussed herein, the SASE service provider may also share, with the cloud service platform, the second mapping that includes the association of various identities (e.g., the mobile subscriber identities) with the SASE servers that are allocated to provide the secure access connectivity. Based on the second mapping, the SASE server determining module 508 may identify the corresponding SASE server to provide the secure access channel to the UE. The SASE service provider may SASE service provider may periodically send updates on the second mapping when a new customer joins the SASE service provider and/or an existing customer departs from the SASE service provider.

The traffic forwarding module 510 may be configured to forward the traffic from the mobile service operator to the SASE service network. The traffic forwarding module 510 may refer to the second mappings of the mobile subscriber identities to the SASE servers and determine the SASE server to forward the traffic from the mobile service operator.

The communication interface(s) 514 can include transceivers, modems, interfaces, antennas, and/or other components that perform or assist in exchanging radio frequency (RF) communications with base stations of the telecommunication network, a Wi-Fi access network , and/or otherwise implement connections with one or more networks. For example, the communication interface(s) 514 can be compatible with multiple radio access technologies, such as 5G radio access technologies and 4G/LTE radio access technologies. Accordingly, the communication interfaces 514 can allow the computing device 500 to connect to the 5G system described herein.

Display 512 can be a liquid crystal display or any other type of display commonly used in the computing device 500. For example, display 512 may be a touch-sensitive display screen and can then also act as an input device or keypad, such as for providing a soft-key keyboard, navigation buttons, or any other type of input. Input/output device(s) 516 can include any sort of output devices known in the art, such as display 512, speakers, a vibrating mechanism, and/or a tactile feedback mechanism. Input/output device(s) 516 can also include ports for one or more peripheral devices, such as headphones, peripheral speakers, and/or a peripheral display. Input/output device(s) 516 can include any sort of input devices known in the art. For example, input/output device(s) 516 can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

The machine readable medium 518 can store one or more sets of instructions, such as software or firmware, which embodies any one or more of the methodologies or functions described herein. The instructions can also reside, completely or at least partially, within the memory 504, processor(s) 502, and/or communication interface(s) 514 during execution thereof by the computing device 500. The memory 504 and the processor(s) 502 also can constitute machine readable media 518.

The various techniques described herein may be implemented in the context of computer-executable instructions or software, such as program modules, which are stored in computer-readable storage and executed by the processor(s) of one or more computing devices such as those illustrated in the figures. Generally, program modules include routines, programs, objects, components, data structures, etc., and define operating logic for performing particular tasks or implement particular abstract data types.

Other architectures may be used to implement the described functionality and are intended to be within the scope of this disclosure. Furthermore, although specific distributions of responsibilities are defined above for purposes of discussion, the various functions and responsibilities might be distributed and divided in different ways, depending on circumstances.

Similarly, software may be stored and distributed in various ways and using different means, and the particular software storage and execution configurations described above may be varied in many different ways. Thus, software implementing the techniques described above may be distributed on various types of computer-readable media, not limited to the forms of memory that are specifically described.

### Conclusion

Although the subject matter has been described in language specific to structural features and/or methodological acts, it is to be understood that the subject matter is not necessarily limited to the specific features or acts described above. Rather, the specific features and acts described above are disclosed as example examples.

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A computer-implemented method, comprising:
receiving, by a cloud service platform and from a mobile service provider, a request to access an entity, the request including a user identity (ID) associated with a mobile subscriber of the mobile service provider, and the request originating from a user equipment (UE) of the mobile subscriber;
determining, by the cloud service platform and based on the user ID, an access service edge (SASE) server; and
sending, by the cloud service platform, the request to the SASE server, the request causing the SASE server to provide a connectivity to the UE of the mobile subscriber to access the entity.

2. The computer-implemented method of claim 1, wherein the user ID is authenticated by the mobile service provider.

3. The computer-implemented method of claim 1, further comprising:
obtaining, by the cloud service platform, a configuration that indicates an association of the user ID and the SASE server; and
determining, by the cloud service platform and based on the configuration, the SASE server,
wherein the configuration is pre-stored at the cloud service platform.

4. The computer-implemented method of claim 1, further comprising:
receiving, by the cloud service platform and from the mobile service provider, data traffic associated with the mobile subscriber; and
sending, by the cloud service platform, the data traffic to the SASE server, causing the SASE server to forward the data traffic to the entity.

5. The computer-implemented method of claim 1, wherein the entity is configured to connect to the cloud service platform, and includes at least one of an enterprise network or a data center network (DCN).

6. The computer-implemented method of claim 1, wherein the connectivity is dedicated to a session between the mobile subscriber and the entity.

7. The computer-implemented method of claim 6, wherein the request further includes an IP address assigned by the mobile service provider to the UE of the mobile subscriber with respect to the session, and the request causes the SASE server to establish a mapping between the IP address and the entity.

8. The computer-implemented method of claim 1, wherein the SASE server is configured to connect to the cloud service platform.

9. A computing device in a cloud network, comprising:
a processor;
a non-transitory computer-readable memory storing computer-executable instructions that, when executed by the processor, cause the processor to perform actions including:
receiving, by a cloud service platform and from a mobile service provider, a request to access an entity, the request including a user identity (ID) associated with a mobile subscriber of the mobile service provider, and the request originating from a user equipment (UE) of the mobile subscriber;
determining, by the cloud service platform and based on the user ID, an access service edge (SASE) server; and
sending, by the cloud service platform, the request to the SASE server, the request causing the SASE server to provide a connectivity to the mobile subscriber to access the entity.

10. The computing device in the cloud network of claim 9, wherein the user ID is authenticated by the mobile service provider.

11. The computing device in the cloud network of claim 9, wherein the computer-executable instructions, when executed by the processor, cause the processor to perform actions including:
obtaining, by the cloud service platform, a configuration that indicates an association of the user ID and the SASE server; and
determining, by the cloud service platform and based on the configuration, the SASE server,
wherein the configuration is pre-stored at the cloud service platform.

12. The computing device in the cloud network of claim 9, wherein the computer-executable instructions, when executed by the processor, cause the processor to perform actions including:
receiving, by the cloud service platform and from the mobile service provider, data traffic associated with the mobile subscriber; and
sending, by the cloud service platform, the data traffic to the SASE server, causing the SASE server to forward the data traffic to the entity.

13. The computing device in the cloud network of claim 9, wherein the entity is configured to connect to the cloud service platform, and includes at least one of an enterprise network or a data center network (DCN).

14. The computing device in the cloud network of claim 9, wherein the connectivity is dedicated to a session between the mobile subscriber and the entity.

15. The computing device in the cloud network of claim 14, wherein the request further includes an IP address assigned by the mobile service provider to the UE of the mobile subscriber with respect to the session, and the request causes the SASE server to establish a mapping between the IP address and the entity.

16. The computing device in the cloud network of claim 9, wherein the SASE server is configured to connect to the cloud service platform.

17. A computer-readable storage medium storing computer-readable instructions, that when executed by a processor, cause the processor to perform operations comprising:
receiving, by a cloud service platform and from a mobile service provider, a request to access an entity, the request including a user identity (ID) associated with a mobile subscriber of the mobile service provider, and the request originating from a user equipment (UE) of the mobile subscriber;
determining, by the cloud service platform and based on the user ID, an access service edge (SASE) server; and
sending, by the cloud service platform, the request to the SASE server, the request causing the SASE server to provide a connectivity to the mobile subscriber to access the entity.

18. The computer-readable storage medium of claim 17, wherein the computer- readable instructions, when executed by the processor, cause the processor to perform actions including:
obtaining, by the cloud service platform, a configuration that indicates an association of the user ID and the SASE server; and
determining, by the cloud service platform and based on the configuration, the SASE server,
wherein the configuration is pre-stored at the cloud service platform.

19. The computer-readable storage medium of claim 18, wherein the computer- readable instructions, when executed by the processor, cause the processor to perform actions including:
receiving, by the cloud service platform and from the mobile service provider, data traffic associated with the mobile subscriber; and
sending, by the cloud service platform, the data traffic to the SASE server, causing the SASE server to forward the data traffic to the entity.

20. The computer-readable storage medium of claim 17, wherein the SASE server is configured to connect to the cloud service platform.
